(19) United States
(12) Patent Application Publication
(10) Pub. No.: US 2007/0037556 A1
(43) Pub. Date: Feb. 15, 2007

(54) Wireless communication system for mobile vessels

(75) Inventors: Keith Andrews, Stockton, CA (US); Harold Roberts, Santa Nella, CA (US); William Hang, Cupertino, CA (US)

Correspondence Address: Howard Chen, Esq.;Preston Gates & Ellis LLP, Suite 1700, 55 Second Street, San Francisco, CA, 94150, US

(73) Assignee: AuraOne Systems, Inc.

(21) Appl. No.: 11/317,328

(22) Filed: Dec. 22, 2005

Related U.S. Application Data
(60) Provisional application No. 60/689,517, filed on Jun. 11, 2005.

(51) Int. Cl. H04L 12/58

(52) U.S. Cl. 455/412.1

(57) ABSTRACT

A system for delivering multimedia information between at least one mobile vessel and at least one multimedia content center includes at least one media server, wireless access router, and client device. The media server is placed in the multimedia content center for providing or storing the multimedia information. The wireless access router is coupled to the media server in the multimedia content center for transmitting or receiving the multimedia information for the media server over a wireless local area network. The client device installed in the mobile vessel for transmitting or receiving the multimedia information to or from the media server via the wireless access router over the wireless local area network, thereby allowing the client device to utilize the multimedia information.

### CROSS REFERENCE

The present application claims the benefits of U.S. Provisional Patent Application Ser. No. 60/689,517, which was filed on Jun. 11, 2005, and entitled “Multimedia Sharing and Distributing System/Wireless Entertainment System.”

### BACKGROUND

The present invention relates generally to a wireless communications, and more particularly to a wireless communication system for delivering digital multimedia information between mobile vessels and multimedia content centers.

Consumers want to enjoy their media content anywhere and have the flexibility to view, hear, and enjoy it at a moment's notice. Just as the music medium has gone from large vinyl discs to more compact 8-tracks to tapes to compact discs (CDs) and now to digital files that can be easily ported to a variety of mediums, video is beginning to follow suit. Information publishers are now striving to deliver media content faster to more audiences.

The digital representation of media content combined with computing and networking technologies now provides a powerful way to distribute the digital media content, such as audio/video feeds (CATV/SAT/Terrestrial live signals, audio files (music), video files (movies), and images (pictures). IP-based networking technology permits the delivery of digital media content over a network to end users (clients). Today, these clients can be a typical networked computer, A/V media adapter, personal digital assistant, or any IP-enabled consumer electronic device capable of playing the digital media content.

Conventionally, if a consumer wanted to stream or transfer the digital multimedia content from his home to a mobile vessel, it would be very cumbersome to set up a data transfer link. For one, the consumer would have a hard time setting up file sharing on its personal computers, let alone distributing the multimedia content. Secondly, because there are so many different media file types, the consumer must ensure that the proper codecs are installed in order to view each type of file structure. Moreover, the consumer would have to have a mobile media receiver installed in his mobile vessel, and physically connect the mobile media receiver with the home device that provides the multimedia content.

As such, what is needed is a system capable of delivering multimedia information between a mobile vessel and a multimedia content center, such as a user's home, over a wireless communication link.

### SUMMARY

The present invention discloses a system for delivering multimedia information between at least one mobile vessel and at least one multimedia content center. In one embodiment of the invention, the system includes at least one media server, wireless access router, and client device. The media server is placed in the multimedia content center for providing or storing the multimedia information. The wireless access router is coupled to the media server in the multimedia content center for transmitting or receiving the multimedia information for the media server over a wireless local area network. The client device installed in the mobile vessel for transmitting or receiving the multimedia information to or from the media server via the wireless access router over the wireless local area network, thereby allowing the client device to utilize the multimedia information.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1 illustrates a system for delivering multimedia information between a mobile vessel and a number of multimedia content centers in accordance with one embodiment of the present invention.

FIG. 2 illustrates a system, in which a wireless local area network (WLAN) is formed between a mobile vessel and a multimedia content center in accordance with the embodiment of the present invention.

FIG. 3 illustrates a block diagram of a wireless access router placed in the multimedia content center in accordance with the embodiment of the present invention.

FIG. 4 illustrates a block diagram of a client device installed in the mobile vessel in accordance with the embodiment of the present invention.

### DESCRIPTION

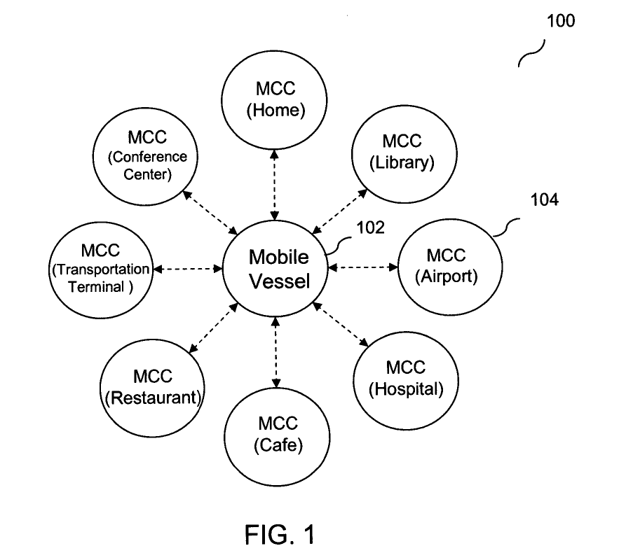

FIG. 1 illustrates a system 100 for delivering multimedia information between a mobile vessel 102 and a number of multimedia content centers 104 in accordance with one embodiment of the present invention. The mobile vessel 102 refers to any vessel capable of transporting people from one place to another. For example, the mobile vessel 102 includes, but not limited to, automobiles (cars, SUVs, vans, buses, trucks, RVs, etc.), motorcycles, fuel or electricity powered carts, trains, boats, ships, helicopters, and airplanes. The multimedia content centers 104 refer to any location where equipment is placed for providing or receiving multimedia information to or from the mobile vessel over the WLAN. The multimedia content center 104 may include a modem for further connecting the equipment to remote multimedia content providers through the Internet. The multimedia content centers 104 that have the Internet accessibility can be customarily referred to as “hotspots.” Examples of the multimedia content centers 104 include, but not limited to, homes, libraries, airports, hospitals, cafes, restaurants, conference centers and public transportation terminals. The dashed lines between the mobile vessel 102 and the multimedia content centers 104 represent the wireless communication links, over which multimedia information is delivered.

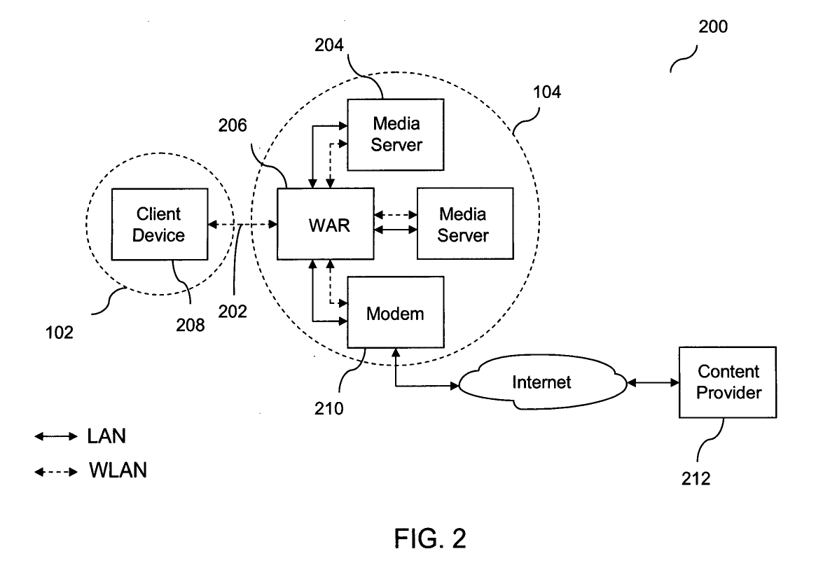

FIG. 2 illustrates a system 200, in which a WLAN is formed between the mobile vessel 102 and a multimedia content center 104 in accordance with the embodiment of the present invention. The wireless communication link 202 between the mobile vessel 102 and the multimedia content center 104 can be formed based on, for example, WiFi technologies in an infrastructure mode or an ad-hoc mode. As defined by the IEEE802.11 working group, these WiFi technologies include, but not limited to, versions, such as 802.11b, 802.11g, 802.11a, and 802.11n. Other present or future standardized or proprietary WLAN protocols can also be used to form the wireless communication link 202.

At least one media server 204 is placed in the multimedia content center 104 for providing or storing the multimedia information. The media server 204 includes, but not limited to, personal computers, work stations, personal digital assistants, media renderers, and entertainment hubs. For example, the media server 204 can be a CD player, DVD player, MP3 player, TV set, VCR, camcorder, and external memory device. The multimedia information refers to any information, such as audio, video, data, ideas, images, sound, text or other contents that can be perceived by one or more human senses. The multimedia information can be digitized and configured in various formats. For example, the video information format includes, but not limited to, DVD, SVCD, VCD, AVI, FLASH, WMS, MPEG1, MPEG2, MPEG4, DivX5, Xvid, SVQ1/3, DV, Cinepak, Theora, H263/H263i, and MJPEB A/B. The audio information format includes, but not limited to, CD Audio, PCM/WAV, MPEG1/2, MP3, AC3, DTS, LPCM, AAC, Vorbis, WMA, ADPCM, DV Audio, FLAC, Quicktime, and MACE. The image information format includes, for example, JPG, GIF, TIFF, PNG, and BMP.

At least one wireless access router 206 is coupled to the media server 204 in the multimedia content center 104 for transmitting or receiving the multimedia information for the media server 204 over the wireless communication link 202. The wireless access router 206 and the media server 204 can be coupled via a wireless or non-wireless local area network. At least one client device 208 is installed in the mobile vessel for transmitting or receiving the multimedia information to or from the media server 204 via the wireless access router 206 over the wireless communication link 202, thereby allowing the client device 208 to utilize the multimedia information. For example, the media server 204 and the wireless access router 206 can stream live TV signals or any audio/video file to the client device for instantaneous showing. The client device 208 can store the multimedia information received from the media server 204 in a storage module. The mobile vessel 102 can then carry around the stored multimedia information and transfer it to another multimedia content center.

At least one modem 210 can be coupled to the wireless access router 206 for further connecting the client device 208 to a multimedia content provider 212 through the wireless local area network and the Internet. The content provider 212 can be a website that provides multimedia information for the client device 208 to download on a fee or non-fee basis. The website may require the subscribers to register as members, and proactively send newsletters to its members based on their preference profiles. The subscribers may set up their client devices 208 in a way that allows them to automatically download the pre-selected multimedia information whenever the client device 208 is connected to the content provider 212 via the wireless access router 206 and the modem 210 through the Internet. Thus, the client device 208 enables the mobile vessel 208 to access to all the information available on the Internet by connecting to the multimedia content center 104.

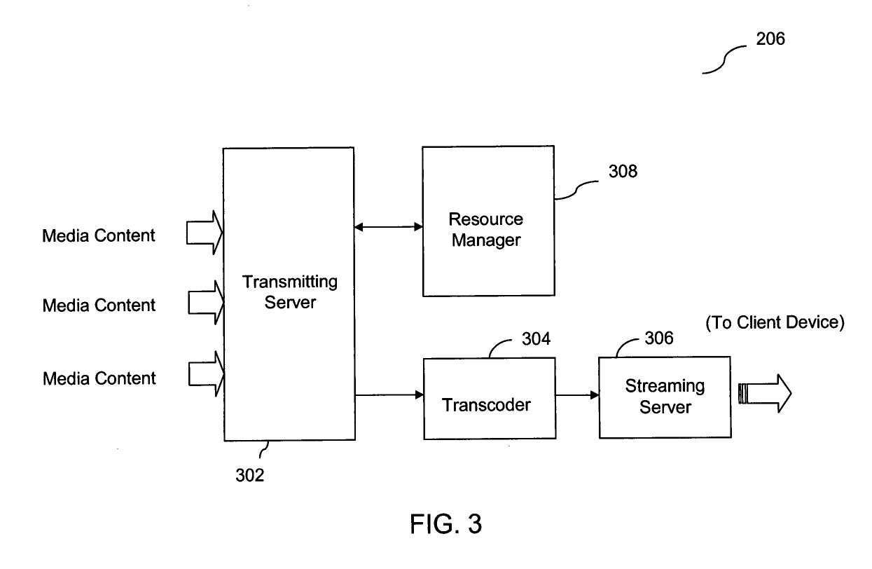

FIG. 3 illustrates a block diagram of a wireless access router 206 placed in the multimedia content center in accordance with the embodiment of the present invention. The wireless access router 206 includes a transmitting server 302 interfacing with the media servers (not shown in this figure) for retrieving the multimedia information therefrom. A transcoder 304 is coupled to the transmitting server 302 for transcoding the retrieved multimedia information. A streaming server 306 is coupled to the transcoder 304 for transmitting the transcoded multimedia information as a data stream over the WLAN. A resource manager 308 is coupled to the transmitting server 302 for managing and keeping the processes of retrieving, transcoding, and transmitting to occur in a pipelined fashion.

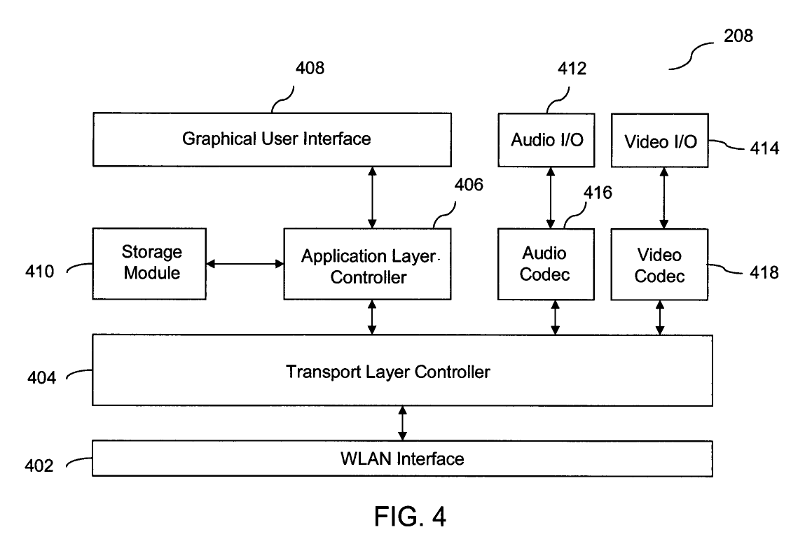

FIG. 4 illustrates a block diagram of a client device 208 installed in the mobile vessel in accordance with the embodiment of the present invention. The client device 208 includes a WLAN interface 402 for establishing the wireless communication link with the media content center (not shown in this figure). The WLAN interface 402 may be capable of automatically detecting the multimedia content centers and WiFi hotspots for establishing the wireless communication link. A transport layer controller 404 is coupled to the WLAN interface 402 for, among other things, delivering the multimedia information in a format of data packets. An application layer controller 406 is coupled with the transport layer controller 404 for, among other things, distributing the multimedia information in a file format. It is understood by those skilled in the art of data communications that the data signaling can be defined by more than two layers. For purposes of avoiding lengthy discussion, the application layer controller 406 and the transport layer controller 404 are used to show the hardware or software implementation of the multiple layer signaling.

A graphical user interface 408 that allows a user to issue commands with respect to the multimedia information is coupled to the application layer controller 406. A storage module 410 is coupled with the application layer controller 406 for storing the multimedia information. The client device 208 also includes an audio I/O port 412 and a video I/O port 414 for outputting the multimedia information to at least one built-in or external multimedia player (not shown in the figure), or receiving audio and video information from the multimedia player. An audio codec 416 and a video codec 418 are coupled between the audio I/O port 412 and the transport layer controller 404 and between the video I/O port 414 and the transport layer controller 404, respectively, for coding or decoding signals received therefrom.

The proposed system allows multimedia information to be easily transferred or streamed between a mobile vessel and a multimedia content center over the WLAN. No cables are needed to connect the mobile vessel to the multimedia content center. The client device installed in the mobile vessel can automatically detect and establish a wireless communication link with the wireless access router in the multimedia content center, thereby simplifying the setting process of the network. Furthermore, the mobile vessel is able to carry around the multimedia information and transfer or stream it to the media server in another multimedia content center. The client device can even access to the Internet via the multimedia content center. As such, the proposed system enables the mobile vessel to access to abundant multimedia information with a simplified process.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A system for delivering multimedia information between at least one mobile vessel and at least one multimedia content center, the system comprising:
at least one media server placed in the multimedia content center for providing or storing the multimedia information;
at least one wireless access router coupled to the media server in the multimedia content center for transmitting or receiving the multimedia information for the media server over a wireless local area network; and
at least one client device installed in the mobile vessel for transmitting or receiving the multimedia information to or from the media server via the wireless access router over the wireless local area network, thereby allowing the client device to utilize the multimedia information.

2. The system of claim 1 wherein the client device and the wireless access router establish the wireless local area network using WiFi technologies in an infrastructure mode or an ad-hoc mode.

3. The system of claim 1 wherein the mobile vessel comprises automobiles, motorcycles, fuel or electricity powered carts, trains, boats, ships, helicopters, and airplanes.

4. The system of claim 1 wherein the multimedia content center comprises homes, libraries, airports, public transportation terminals, hospitals, conference centers, cafes and restaurants.

5. The system of claim 1 wherein the wireless access router and the media server are coupled via a wireless or non-wireless local area network.

6. The system of claim 1 wherein the media server comprises personal computers, work stations, personal digital assistants, media renderers, and entertainment hubs.

7. The system of claim 1 further comprising at least one modem coupled to the wireless access router for connecting the client device to a multimedia content provider through the wireless local area network and the Internet.

8. The system of claim 1 wherein the wireless access router comprises:
a transmitting server interfacing with the media server for retrieving the multimedia information therefrom;
a transcoder coupled to the transmitting server for transcoding the retrieved multimedia information; and
a streaming server coupled to the transcoder for transmitting the transcoded multimedia information as a data stream over the wireless local area network.

9. The system of claim 8 wherein the wireless access router further comprises a resource manager coupled to the transmitting server for keeping the processes of retrieving, transcoding, and transmitting to occur in a pipelined fashion.

10. The system of claim 1 wherein the client device comprises a graphical user interface that allows a user to issue commands with respect to the multimedia information.

11. The system of claim 10 wherein the client device comprises a storage module for storing the multimedia information.

12. The system of claim 11 wherein the client device comprises an audio I/O port and a video I/O port for outputting the multimedia information to at least one multimedia player, or receiving audio and video information from the multimedia player.

13. The system of claim 12 wherein the client device comprises a wireless local area network interface for establishing the wireless local area network with the wireless access router.

14. The system of claim 13 wherein the client device comprises a transport layer controller coupled to the wireless local area network interface for delivering the multimedia information in a format of data packets therebetween.

15. The system of claim 14 wherein the client device comprises an application layer controller coupled with the graphical user interface, the storage module, and the transport layer controller for distributing the multimedia information in a file format.

16. A device for delivering multimedia information between at least one mobile vessel and at least one multimedia content center capable of providing the multimedia information over a wireless local area network, the device comprising:
a wireless local area network interface for establishing a wireless communication link with the media content center based on WiFi technologies;
a transport layer controller coupled to the wireless local area network interface for delivering the multimedia information received over the wireless communication link from the media content center in a format of data packets; and
an application layer controller coupled with the transport layer controller for distributing the multimedia information in a file format,
wherein the device is installed in the mobile vessel for allowing the multimedia information to be carried and transferred to another multimedia content center.

17. The device of claim 16 further comprising a graphical user interface that allows a user to issue commands with respect to the multimedia information.

18. The device of claim 17 further comprising a storage module coupled with the application layer controller for storing the multimedia information.

19. The device of claim 18 further comprising an audio I/O port and a video I/O port for outputting the multimedia information to at least one multimedia player, or receiving audio and video information from the multimedia player.

20. The device of claim 19 further comprising an audio codec and a video codec coupled between the audio I/O port and the transport layer controller and between the video I/O port and the transport layer controller, respectively, for coding or decoding signals received therefrom.

21. A system for delivering multimedia information between at least one multimedia content center and at least one mobile vessel capable of receiving the multimedia information over a wireless local area network, the system comprising:
at least one media server placed in the multimedia content center for providing or storing the multimedia information;
at least one wireless access router coupled to the media server in the multimedia content center for transmitting or receiving the multimedia information for the media server over a wireless communication link based on WiFi technologies to the mobile vessel; and
at least one modem coupled to the wireless access router for connecting the mobile vessel to a multimedia content provider through the wireless communication link and the Internet.

22. The system of claim 21 wherein the wireless access router and the media server are coupled via a wireless or non-wireless local area network.

23. The system of claim 21 wherein the wireless access router comprises:
a transmitting server interfacing with the media server for retrieving the multimedia information from the media;
a transcoder coupled to the transmitting server for transcoding the retrieved multimedia information; and
a streaming server coupled to the transcoder for transmitting the transcoded multimedia information as a data stream over the wireless communication link.

24. The system of claim 23 wherein the wireless access router further comprises a resource manager coupled to the transmitting server for keeping the processes of retrieving, transcoding and transmitting to occur in a pipelined fashion.
